(19) United States
(12) Patent Application Publication
(10) Pub. No.: US 2006/0136549 A1
(43) Pub. Date: Jun. 22, 2006

(54) System and method for accessing through wireless internet access points information or services related to broadcast programs

(76) Inventor: Fernando Incertis Carro, Valencia (ES)

Correspondence Address: SCHMEISER, OLSEN & WATTS, 3 LEAR JET LANE, SUITE 201, LATHAM, NY, 12110, US

(21) Appl. No.: 10/545,351

(22) PCT Filed: Mar. 25, 2004
(86) PCT No.: PCT/EP04/04265

§ 371 Date: Aug. 11, 2005

(30) Foreign Application Priority Data
Apr. 18, 2003 (EP) 03368040.6

(51) Int. Cl. G06F 15/16

(52) U.S. Cl. 709/203

(57) ABSTRACT

A method and system for retrieving in real-time a hyperlink related to a topic selected during a broadcast of a program on a channel. A first request to a wireless internet gateway is sent for retrieving a universal-time and an address of a server. The universal-time pertains to when the command was performed. The universal-time and the address of the server is received from the wireless internet gateway in response to the first request. A second request to the server is sent via the wireless internet gateway using the received address of the server, for retrieving the one or a plurality of hyperlinks related to the selected topic, said second request transmitting to the server the received universal-time from which the hyperlink may be determined by the server. The hyperlink is received from the server via the wireless internet gateway and then recorded.

### FIELD OF THE INVENTION

This invention is directed to techniques for integrating broadcast, wireless and computer systems. More particularly, the invention relates to a system and method for having access by means of a mobile wireless device, to information or services related to topics selected by a user watching or listening to a broadcast (television or radio) program.

### BACKGROUND OF THE INVENTION

Wireless Fidelity

Wi-Fi (short for “wireless fidelity”) is the popular term for a high-frequency wireless local area network (WLAN). A Wi-Fi network can be used to wirelessly connect multiple computers to each other, to the Internet, or to wired networks (which use IEEE 802.3 or Ethernet) anywhere within an area of a base station. The Wi-Fi technology is rapidly gaining acceptance in many companies as an alternative of wired LANs. Wi-Fi can also be installed for home network.

Wi-Fi is described in the 802.11b specification defined by the Institute of Electrical and Electronics Engineers (IEEE). The 802.11b (Wi-Fi) technology operates in the unlicensed 2.4 GHz range offering data speeds up to 11 megabits per second. The modulation used in 802.11 is the Phase-Shift Keying (PSK). The modulation method selected for 802.11b is known as Complementary Code Keying (CCK). The CCK modulation allows a higher data transmission speeds and is less susceptible to multipath-propagation interference. The Wi-Fi (802.11b) specification is part of a series of wireless specifications together with the 802.11, 802.11a, and 802.11g. All four standards use the Ethernet protocol and CSMA/CA (Carrier Sense Multiple Access with Collision Avoidance) for path sharing. A copy of the 802.11b standard can be ordered at the IEEE site, on: http://standards.ieee.org/.

At home, a Wi-Fi network can connect together the computers of the family to share hardware and software resources such as printers and the Internet. Everyone in the family can share files, photos and documents, and print them out on a single printer attached to a desktop computer—without the need of cables running throughout the home. At home or in a home office, a Wi-Fi wireless network gives the possibility to share a single high-speed broadband cable or DSL connection. Home Wi-Fi networking equipment, offered for a few hundred dollars, allows home networks to go beyond the control of bandwidth providers.

For small businesses, Wi-Fi networks provide connectivity between mobile salesmen, floor staff, finance and accounting departments. The flexibility of a Wi-Fi network is particularly well adapted to small businesses having high tendencies to change and grow.

Large corporations use Wi-Fi wireless products to extend the standard wired Ethernet networks to public areas like meeting rooms, training classrooms or large auditoriums. Many corporations also provide wireless networks to their off-site employees to allow them to work at home or in remote offices. Also, large companies, hospitals, universities . . . often use Wi-Fi to connect buildings.

Internet Service Providers (ISPs) use Wi-Fi technology to provide Internet access to individual homes, companies, apartments or commercial complexes. The most important telecommunications companies in countries such as United States, South Korea, the United Kingdom, Sweden and Japan, have been very quick to embrace Wi-Fi and offer public “hot spots” (i.e., wireless access points).

Wi-Fi access has developed mainly in busy public places like coffee shops, hotels, airport lounges, stores and other locations where large crowds gather. But soon, Wi-Fi networks will spread out in urban areas extending its coverage throughout the central city, or along major highways, enabling travelers to use Wi-Fi services anywhere they can pull over and stop. Locations of Wi-Fi “hot spots” around the world are published on the Web, for instance on: http:/Itsu.net/

The number of Wi-Fi access points (widely known as “hot spots”) is spreading and growing very fast mainly in busy public places. Most of the time, radio and TV sets are already installed in these public places. It is expected that “old” TV sets receiving broadcast programs, news, commercials and entertainment, and “new” Wi-Fi “hot spots” providing wireless access to on-demand information or services will coexist in a near future.

On-Line Services on the Web

In our society, independently of the massive development of radio and television, on-line services such as these provided by the World Wide Web (i.e., the Web) have rapidly emerged and are now widely available. Such on-line services based on the Internet, provide access to a huge amount of information on an interactive basis. The Internet is a global network of computers. The Internet connects computers based on a variety of different operating systems or languages using a language referred to as TCP/IP (“Transmission Control Protocol/Internet Protocol”). With the increasing size and complexity of the Internet, tools have been developed to help users find information on the network, often called “navigators” or “navigation systems”. The World Wide Web (“WWW” or “the Web”) is a recent superior navigation system. The Web is:

an Internet-based navigation system,

an information distribution and management system for the Internet, and

a dynamic format for communicating on the Web.

The Web integrates images, text, audio and video. A user on the Web using a graphical user interface can transparently communicate with different computers on the system, and different system applications, and different information formats for files and documents including, for example, text, sound and graphics. Currently, on-line systems on the Web offer a variety of different services to users, for instance, private message services, electronic commerce, news, real-time games, access to electronic databases, electronic newsletters, business-to-business transactions, or job placement services. But, even if such on-line services are now available, the Web remains essentially an open, multi-point to multi-point network where each user can select and retrieve different information from many different servers, and where searching and finding relevant information remains an arduous task, sometimes taking hours, even for experienced users.

Providing On-Line Services on Home Radio or Television

Media consumers have a need for additional information and services. When they watch a television program, many of them would like to have access to related complementary data, such as stocks and products prices, traffic and weather conditions, athletic records on Olympic Games or updated football scores. For instance, the complementary information associated with a broadcast program may consist of the biography of a player in a football match, an historical background on events cited on a news program or the recipe of an apple cake on a cooking show.

On the consumers side, people are looking for more information or data about what they listen to or view in the media. Consumers would like to have access to special services associated with advertised products such as product features, location of points of sales, discounts or coupons . . . .

On the media providers side, new sources of profit are expected by extending the quantity and quality of services and information provided to consumers of television or radio programs. Advertisers are looking for new and more effective forms of advertisement.

Nowadays, many television and radio broadcasters display an Internet address to make inquiries concerning the program that is broadcast. Accessing the Internet requires a computer. The user must manually enter the Internet address in the computer. Some other systems allow the exchange of digital information with a user watching the television by combining this information with the television signal (e.g., teletext). However, such systems limit the access to a single information source and this source is entirely under the control of the broadcast or cable television operator. Also, the use of television sets as terminals for accessing the Web is increasing every year. A trend is the integration of Web and TV by transmitting along with a video signal a Web page showing for example statistics concerning a player during a sports game. The integration of Web and television, known as WebTV has been made possible by the arrival of digital TV. In fact, many of the services associated with WebTV are available today on the Web. The data processing technology and the transmission technology used for the television and the Web are converging. Now TV sets are more and more “intelligent”, and this intelligence requires the upgrading of hardware in particular for supporting the Web functions.

Unlike the multi-point to multi-point Web network, broadcast radio or television are primarily single-point to multi-point networks. To provide interactive services, the problem with broadcast television or radio systems is that the information is continuously broadcast in the same direction from a transmitter to multiple receivers, from a provider to multiple consumers. Every user receives the same content from a single broadcasting station. Communication is limited to only one direction without any exchange of information with consumers. People cannot interact with the programs, to seek additional information or services. The main problem is to provide “two-way” web-like capabilities in a conventional (non-interactive) broadcast system.

In fact, until recently, there was no way for producers of broadcast television or radio programs to create hyperlinks to access complementary information related to a broadcast program. The systems that were proposed required the transmission of the complementary information in a secondary signal, concurrently with the retransmission of the main program. With these systems, for recovering the information, the radio auditors or television viewers must be equipped with special decoder circuits. Proposals based on transmitting identification of television programs or URLs of hyperlinked information associated with television programs during the vertical blanking interval (VBI) period need special decoders.

Providing On-Line Services on Public Radio or Television

To provide interactive services to people attending broadcast programs played or displayed on receivers installed on public places, the main problem is that users only receive a visual and oral information. There is no transmission of complementary information (e.g., URLs to hyperlinked information) from the broadcast program receiver to the user device. The communication of complementary information to the users would require a specialized transmitter on the TV (or radio) set and a specialized receiver on the wireless user device. Without a specialized transmitter and receiver, with conventional TV sets and wireless devices, it is impossible to interact with broadcast programs to seek additional information or services.

A system and method for enabling a radio auditor or a television viewer to access complementary information related to a broadcast program received in real-time that avoids the requirement of transmitting information from the broadcast program receiver to the user, has been disclosed in PCT patent application WO 02/091228, filed Nov. 4, 2002, entitled “System and Method for Enhancing Broadcast Programs with Information on the World Wide Web”. In a preferred embodiment of this invention, a system and method is described for enabling a person receiving a broadcast program, to select a plurality of topics drawing his or her attention on a user device and for immediately, or at a later time, accessing additional information related to these selected topics on the Word Wide Web. The system is based on a synchronization of the local times of receivers and transmitters according to a same universal-time, so that the flow of information transmitted and received is always synchronized, independently of the relative positions of receivers and transmitters. The synchronization is done referring to an universal time such as the Global Positioning System Time (GPS-time), the Global Orbiting Navigational Satellite System (GLONASS) time or another suitable universal time based on a satellite system. The GPS or GLONASS receivers are connected or integrated to the broadcasting stations. At the receiver side, GPS or GLONASS receivers may be integrated or connected to user devices (e.g., Personal Computers, wearable computers, Personal Digital Assistants (PDAs), smart phones or onboard mobile computers) that may be independent or separate from the radio or television receivers. The system is also based on a plurality of hyperlinks defined for given universal-time intervals of retransmission. The hyperlinks are associated with the transmitted information. The hyperlinks can be retrieved, selected and activated by radio auditors or television viewers during the time intervals for which they have been defined.

The problem with this system is that it requires the integration or connection of GPS receivers to user devices to operate in synchronization with GPS receivers connected to broadcast stations. The user devices requires a special hardware to implement the functions of the invention. Another drawback is that, since the universal timing signals received from the GPS or GLONASS satellites, are used to initialize and synchronize the internal electronic clocking systems of the user devices, during the periods for which GPS or GLONASS satellites are out of sight (e.g., when user's devices are inside buildings—as is the case on most public locations—, or not connected to an external antenna, no timing signals are received from those satellites), the timing information must be continuously derived from the autonomous electronic clocking systems on the user devices. Depending on the drift of the clocking systems set up in the user devices, and depending on the timing precision required to be sure that user devices are synchronized with broadcasting stations, the reception of satellite signals must be regular and frequent. This imposes a constrain particularly in public locations, since in practice, satellite signals can only be received when the user is outside or is traveling.

Thus, even if during the last years, interactive systems (e.g., WebTV) have been developed to improve the access to information and the interaction with users, today important sources of information (such as sources we can find on the Web) remain inaccessible for people watching TV programs on public places.

Therefore, today there is a need to provide new convenient, universal, and easy mechanisms for enabling people receiving a broadcast television or radio program on a public place (e.g., on a coffee shop, an hotel lobby, a railway station, or an airport lounge), to effectively select and access complementary information for which they have some interest.

In particular, there is a need to enable auditors or viewers of a radio or television program received and played in a public place, to access, directly from a mobile wireless device (e.g., directly from their cellular phone, Personal Data Assistant (PDA), wearable computer or notebook computer) additional information or services related to the program they are listening or watching.

To that aim it would be desirable to complement the primary function of Wi-Fi access points (“hot spots”, Wi-Fi Internet gateways) installed on public places, to provide a concurrent Internet access by means of mobile wireless devices.

More particularly, it would be desirable to enable the access, from a mobile wireless device in a public place located in the vicinity of a Wi-Fi access point, to information and services related to a radio or television broadcast program

### OBJECTS OF THE INVENTION

it is therefore a broad object of the invention to combine the user-friendly experience of radio and television with the access to the huge amount of information and services available on the Web.

It is another object of the invention to integrate conventional non-interactive receivers of broadcast programs, such as conventional radio or television sets installed in public places, with wireless Internet access systems (i.e., Wi-Fi systems).

It is another object of the invention to enable a radio auditor or a television viewer located in a public place, such as a coffee shop, hotel, university, auto repair shop, or airport terminal, to select one or more topics of interest from a conventional broadcast program played or displayed on a receiver set installed in said public place, and then to easily access information related to these selected topics from the Web.

It is a further object of the invention to enable the access to additional information related to broadcast programs, without modifying conventional broadcast signals and thus, without requiring special broadcast receivers or display equipment.

It is still another object of the invention to enable an auditor or a viewer to more conveniently access additional information related to broadcast programs, without modifying conventional wireless user devices commonly used to access Internet through Wi-Fi access points.

### SUMMARY OF THE INVENTION

The present invention is directed to a system and method as defined in independent claims for integrating broadcast, wireless and computer systems.

More particularly, the present invention discloses a system, method and computer program for use in a wireless user device, for retrieving in real-time one or a plurality of hyperlinks related to one or a plurality of topics selected in a program broadcast on a channel. The method comprises the steps of:
each time a command for selecting a topic during the broadcasting of a program on a channel is received, sending to a wireless internet gateway connected to a communication network, a request corresponding to the selected topic for retrieving an universal-time and an address;
receiving from the wireless internet gateway in reply to said request corresponding to the selected topic;
   an universal-time corresponding to the reception by the wireless internet gateway of the request associated with the selected topic, and
   an address of a server associated with the channel broadcasting the program;
sending a request to the server associated with the broadcast channel, for retrieving one or a plurality of hyperlinks related to the selected topic, said request comprising the universal-time received from the wireless internet gateway; said server comprising a table including one or a plurality of hyperlinks associated with one or a plurality of time-intervals;
retrieving from said server, the one or plurality of hyperlinks associated in the table with the one or plurality of universal-time intervals comprising the universal-time included in the request and corresponding to the selected topic,
recording in the wireless device, the retrieved one or plurality of hyperlinks.

The present invention also discloses a system, method and computer program for use in a wireless internet gateway connected to a program receiver, for retrieving in real-time one or a plurality of hyperlinks related to one or a plurality of topics selected in a program broadcast on a channel. The method comprises the steps of:
each time a request corresponding to a selected topic, is received from a wireless device, determining by means of an universal-time device, the universal-time corresponding to the reception of said request;
identifying a server associated with the channel broadcasting the program;
sending to the wireless device in reply to the request corresponding to the selected topic;
   the universal-time corresponding to the reception by the wireless internet gateway of the request associated with the selected topic, and
   the address of the server associated with the channel broadcasting the program.

Further embodiments of the invention are provided in the appended dependent claims.

The foregoing, together with other objects, features, and advantages of this invention can be better appreciated with reference to the following specification, claims and drawings.

### BRIEF DESCRIPTION OF THE DRAWINGS

The novel and inventive features believed characteristics of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein:

FIG. 1 shows the main components of the invention.

FIG. 2 shows how when a user selects an interesting topic from a broadcast program, the user wireless device sends a request to the Wi-Fi Internet Gateway for additional information concerning this selected topic.

FIG. 3 shows how, when the Wi-Fi Internet Gateway receives from the user device a request for additional information concerning a new selected topic, this Wi-Fi Internet Gateway sends back to the user device, the universal-time corresponding to the selection made by the user and the address (URL) of the Broadcast Station Server.

FIG. 4 shows how the universal-time corresponding to the selection made by the user and the address (URL) of the Broadcast Station Server received from the Wi-Fi Internet Gateway, are stored in a Selections Table on the user device.

FIG. 5 illustrates how, for each selection recorded in the Selections Table, a request is sent by the user device to the Broadcast Station Server to retrieve hyperlinks related to the topic broadcast at the universal-time corresponding to the selection made by the user.

FIG. 6 illustrates how, when the Broadcast Station Server receives a request from the user device, this Broadcast Station Server identifies and retrieves by means of the selection universal-time, the hyperlinks corresponding to the topic or sequence that has been broadcast at this universal-time and then transmits these hyperlinks to the user device.

FIG. 7 illustrates how the hyperlinks corresponding to the topics selected by the user during the broadcasting of the program, once received from the Broadcast Station Server, are stored into the Selections Table on the user device.

FIG. 8 shows how hyperlinks associated with topics selected from broadcast programs, are selected and triggered by the user to access additional information or services on the Web.

FIG. 9 shows how the information associated with a topic selected from a broadcast program, is retrieved from a Web server and transmitted to the user mobile device.

FIG. 10 illustrates how programs broadcast by a station, are synchronized according to the present invention.

FIG. 11 illustrates how hyperlinks associated with a broadcast program become alive during the transmission of said program, and how a plurality of hyperlinks can be alive at a same universal-time according to the present invention.

FIG. 12 shows how different hyperlinks can be selected by an auditor or viewer at different universal-times, and how a plurality of hyperlinks can be selected by an auditor or viewer at a same universal-time during the reception of the broadcast program.

FIG. 13 illustrates the method of selecting topics during the broadcasting of a program according to the present invention.

FIG. 14 illustrates the method of accessing information associated with selected topics according to the present invention

### PREFERRED EMBODIMENT OF THE INVENTION

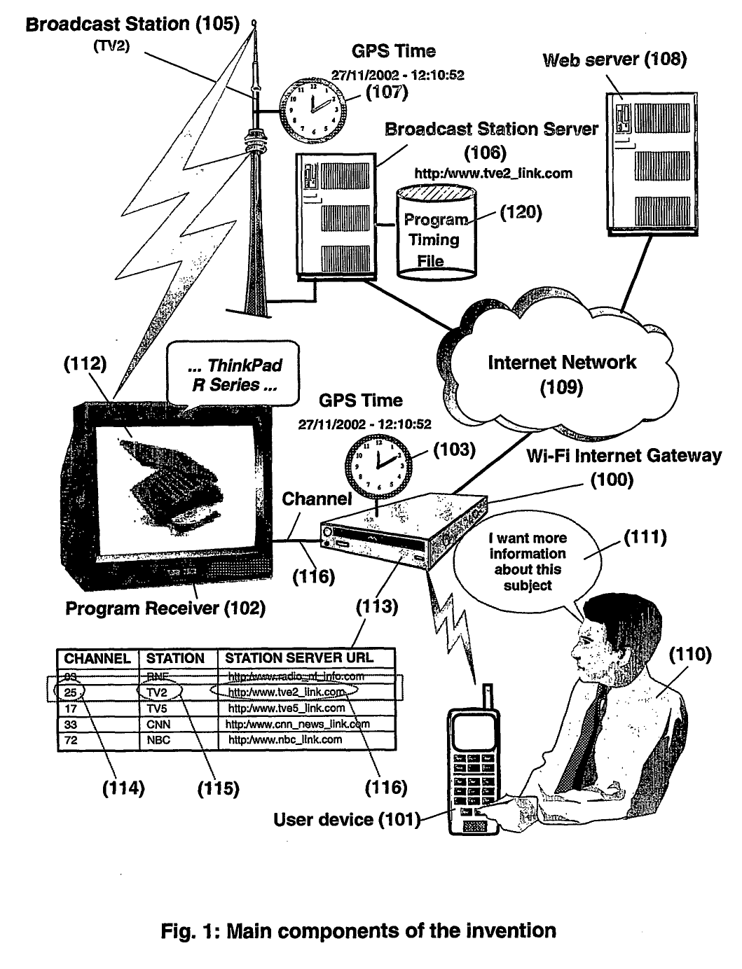

As shown in FIG. 1, The present invention is directed to a system and method for enabling a radio auditor or a television viewer (110) to have access to complementary information related to a broadcast program received in real-time. In a preferred embodiment of the present invention, a person (110) receiving a broadcast program, can:
select, simply by pressing a reserved key on a wireless device (101), one or a plurality of topics or sequences (112) drawing his or her attention (111); and
access, immediately, or at a later time, through a Wireless Internet Gateway (100), additional information on the Web related to the selected topics or sequences (112).

The system is based on:
the synchronization according to a same universal-time (107) (103) (such as for example, the Universal Time Coordinated (UTC) or the Global Positioning System (GPS) time) of:
   the local time used in the broadcast station (105) and
   the local time used in the Wireless Internet Gateways (100) (i.e., Wi-Fi Internet Gateways, wireless internet access points, or “hotspots”)
the synchronization, according to local time of the Wireless Internet Gateway (100), of the requests sent by the wireless user devices (101).

Using these principles, the flow of information transmitted by the broadcast station (105) and the flow of information received and sent by users (110) are permanently synchronized, independently of the relative positions of the broadcast station and users. The local time at which the requests are sent by the users (110) from their wireless devices (101), can be compared with the local time used by the broadcast station (105). It is then possible to identify which topics or sequences (112) have been broadcast at the time of the selection made by the user.

The system is also based on the definition of hyperlinks associated with particular topics or sequences of the broadcast programs. During the broadcasting of a program, hyperlinks and universal-time intervals associated with particular topics and sequences, are logged by the broadcast station (105) on a Channel Server (106). For each topic (or sequence), the Channel Server keeps a record of the universal-time interval during which this topic (or sequence) has been broadcast and a record with the hyperlinks associated with this topic (or sequence).

Since the broadcast station (105) and wireless user devices (101) are synchronized through the wireless internet gateway (100), the hyperlinks 30 corresponding to the selections made by users, can be retrieved from the Channel Server (106).

In a particular embodiment of the invention, the synchronization is done referring to an universal time such as the Global Positioning System Time (GPS-time), the Global Orbiting Navigational Satellite System (GLONASS) time or another suitable universal time based on a satellite system. The GPS or GLONASS receivers (107) are connected to or integrated in the broadcasting stations (105). At the receiver side, GPS or GLONASS receivers (103) can be connected to or integrated in the Wireless Internet Gateway (100). The Wireless Internet Gateway (100) is also connected (e.g., by means of an asynchronous serial port) to the receiver (102) from which it detects the broadcast channel (116) actually selected (i.e., tuned) on the receiver.

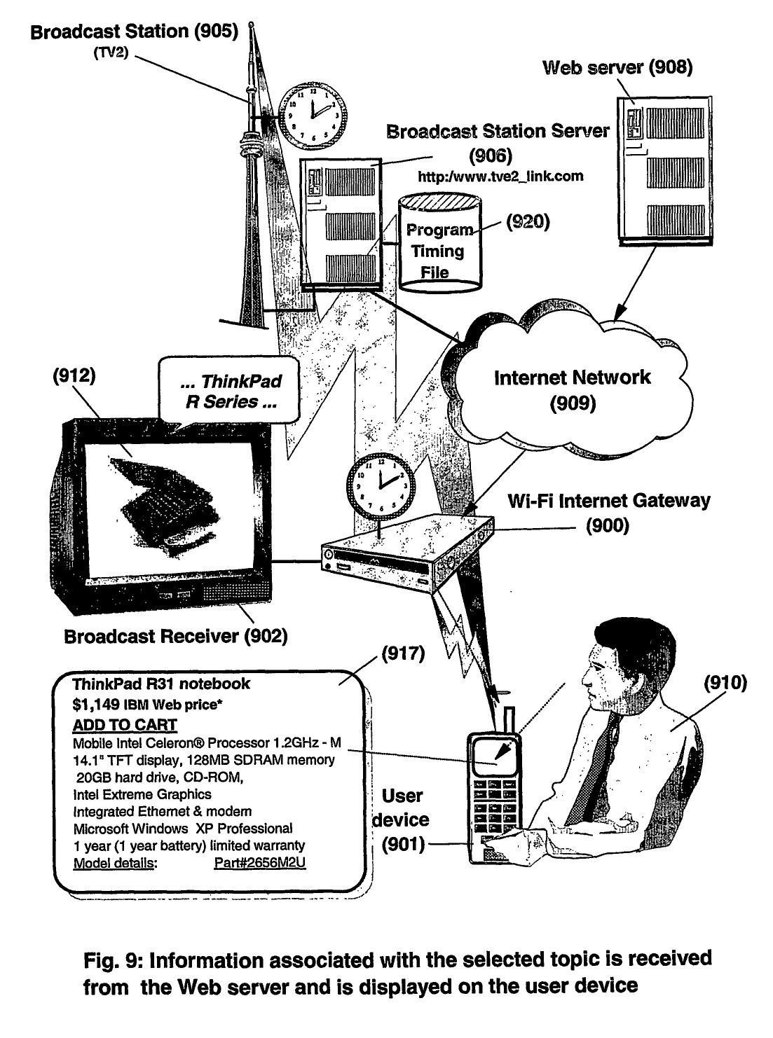

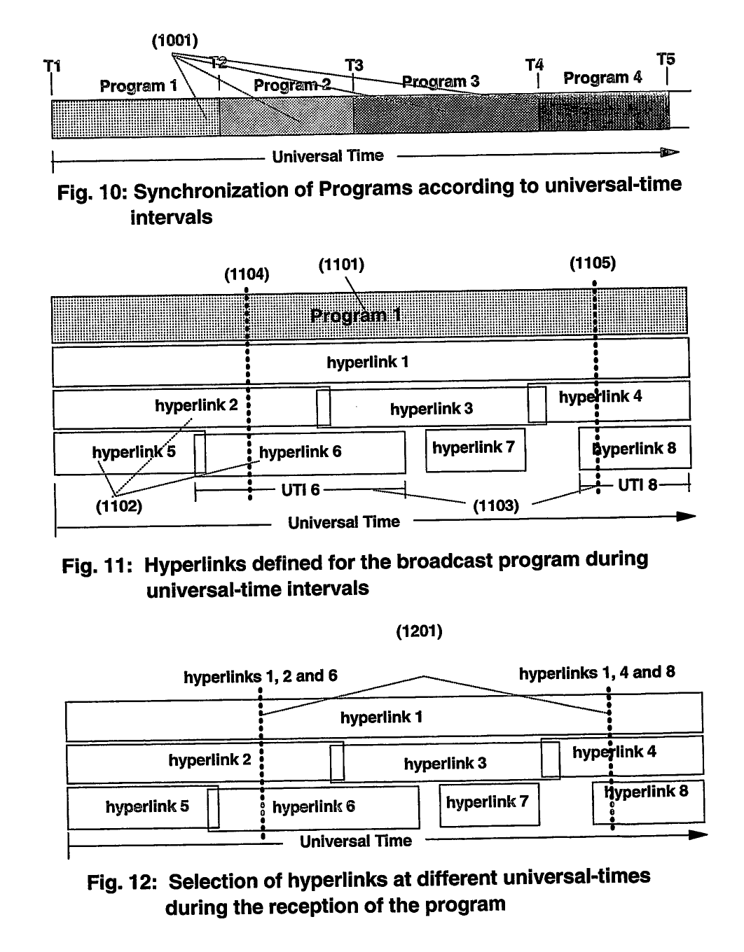

As illustrated in FIG. 10, the invention is also based on a system in which programs (1001) are broadcast according to an universal time. FIGS. 11 and 12 show how the broadcast information (1101) and hyperlinks (1102) are associated and how, when transmitters and receivers are synchronized, the hyperlinks can be selected by radio auditors or television viewers during predefined time intervals (1103). FIG. 12 also shows how a plurality of hyperlinks can be selected at the same time (1104, 1105, 1201)).

As illustrated in FIG. 1, the Broadcast Station (105) (e.g., a TV station) receives a timing signal from an universal-time receiver (107) (e.g., from a GPS receiver delivering GPS Time signals). During the broadcasting of a program, the Broadcast Station or transmitter (105) updates a database (Program Timing File (120)) on a Broadcast Station Server (106) (i.e., a server linked to the transmitter). This database comprises universal time intervals (1103) (for instance GPS-time intervals) during which hyperlinks (1102) between the broadcast program (1101) and URLs (Uniform Resource Locators) of Web pages are “alive” and can be retrieved by radio auditors or television viewers. Each hyperlink logged on the Program Timing File (120) stored on the Broadcast Station Server (106), is tagged with an universal-time interval (e.g., with the GPS Time interval) corresponding to the broadcast of a topic or sequence.

In a remote location (typically a public location, such as a cafeteria, an hotel lobby, or an airport lounge), users (110) can communicate with their wireless mobile devices (101) (e.g., cellular phones; Personal Data Assistants (PDAs), pocket PCs or notebook computers) and can also access the Internet (109) through a high-speed wireless internet access gateway—named Wi-Fi Internet Gateway or Wireless Internet Gateway (100) in the present description. The Wi-Fi Internet Gateway (100) operates as master station of a wireless LAN (e.g., a Wi-Fi IEEE 802.11b LAN). FIG. 1 shows a receiver (102) (e.g., a TV set) connected (e.g., by a serial port) (116) to a Wi-Fi Internet Gateway (100). The broadcast channel (e.g., TV channel number 25) corresponding to the program (112) displayed on the receiver (102) is transmitted from this receiver (102) to the Wi-Fi Internet Gateway (100). A Channel Table (113) is stored on the Wi-Fi Internet Gateway (100). This Channel Table (113) comprises, for each broadcast channel (114) programmed on the receiver (102), means for identifying the Broadcast Station (105) and the address (URL) (116) of the Broadcast Station Server (106) associated with the Broadcast Station (105).

Method for Selecting Topics and Retrieving Hyperlinks Related to Selected Topics

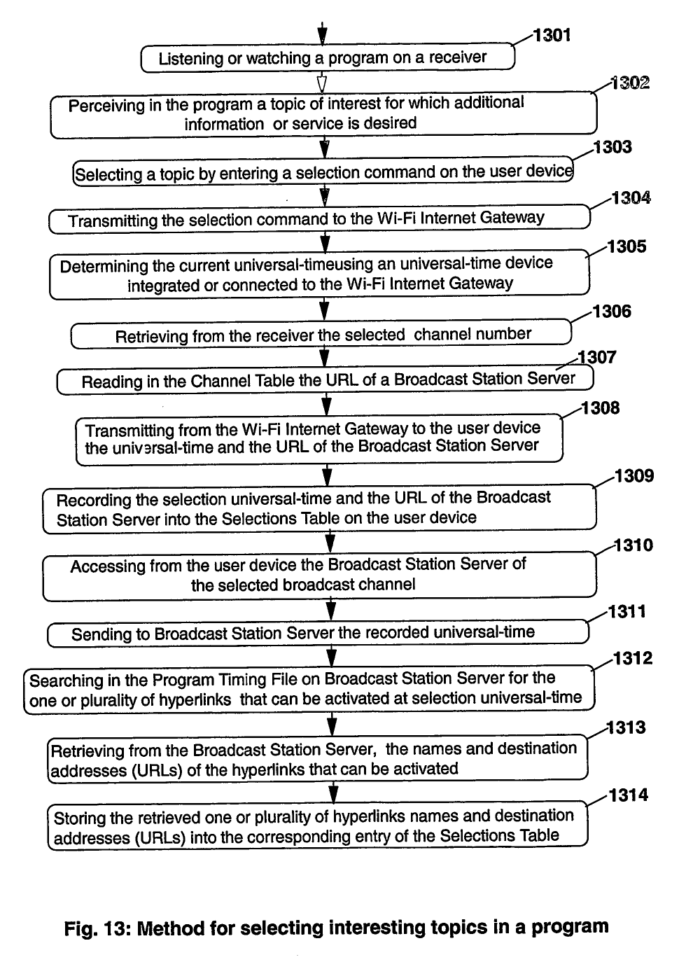

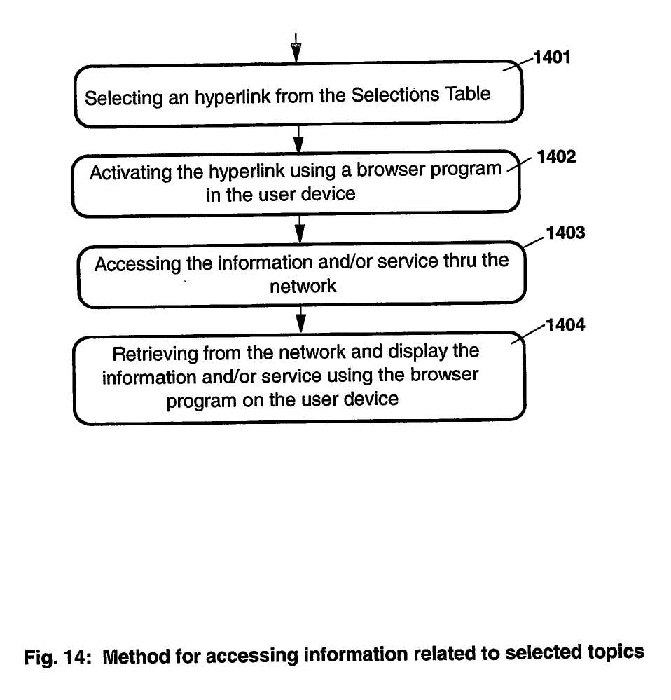

When a person (201) listens to or watches a broadcast program (212), some topics may draw his attention. This person may wish to obtain complementary information concerning these topics. FIG. 13 shows a method for selecting one or several topics of interest for, immediately, or at a later time, receiving additional information related to these topics. The information is retrieved by means of the wireless user device (201) from on one or a plurality of servers (208) connected to a network (209) (e.g., from the Word Wide Web).

As a preliminary step, for enabling a user (210) to select one or several topics of interest (212) in a program received among a plurality of different broadcast channels (304), (314), a Channel Table (311), like the one illustrated hereinafter, must be created beforehand and stored on the Wi-Fi Internet Gateway (300). This Channel Table is filled with information related to the broadcast channels that have been programmed on the receiver (302). Basically, the Channel Table (311) stores the information required to access from the wireless user device (301), a plurality of Broadcast Station Servers (306) throughout the Wi-Fi Internet Gateway (300) and the network (309) to which this Wi-Fi Internet Gateway is connected. The Channel Table comprises a list of channel numbers (314) and, for each channel number:
the name of the broadcasting station (315); and
the network address (for instance the URL) (316) of the Broadcast Station Server (306) associated with said channel (314).

The information concerning the Channel Table is previously recorded (e.g., by the owner of Wi-Fi Internet Gateway (300)) and can be provided by any of the many information sources that are available today (e.g., by TV or radio operators, from newspapers, the Web, . . . ).

| | BROADCAST | CHANNEL INFORMATION |
|---|---|---|
| CHANNEL: | STATION: | SERVER URL: |
| 03 | RNF | http:/www.radio_nf_info.com |
| 25 | TV2 | http:/www.tve2_link.com |
| 17 | TV5 | http:/www.tve5_link.com |
| 33 | CNN-NEWS | http:/www.cnn_news_link.com |
| 72 | NBC | http:/www.nbc_link.com |

The method for an auditor of a radio program or for a viewer of a TV program, of selecting one or a plurality of topics of interest during the broadcasting of the radio or TV program, comprises the following steps:
(1301) listening to or watching a program (210) broadcast by a radio or TV station (105) and received on a radio or TV set (202);
(1302) perceiving (listening or viewing) in the program a topic of interest (212) for which additional information or service is desired;
(1303) selecting a topic (or sequence) by entering a selection command (211) on a wireless device (201);
(1304) transmitting from the wireless device to the Wi-F Internet Gateway (200), this selection command (213).
   The method in the Wi-Fi Internet Gateway (200), comprises the further steps of:
(1305) determining by means of an universal-time device (for instance a GPS receiver) (303), integrated or connected to the Wi-Fi Internet Gateway (300), the universal time corresponding to the reception from the wireless user device ((301) of said selection request;
(1306) retrieving (304) from the broadcast program receiver (302), the number of the selected broadcast channel (304), (314);
(1307) reading in a Channel Table (311) stored on the Wi-Fi Internet Gateway (300), the address (URL—Uniform Resource Locator) of a Broadcast Station Server (306) associated with the selected broadcast channel (314);
(1308) transmitting to the wireless user device (301):
   the universal-time (303) corresponding to the selection of the topic by the user; and
   the address (URL) of the Broadcast Station Server (306) associated with the selected broadcast channel (314).
      The method, in the wireless user device (301) (501) (601), comprises the further steps of:
(1309) recording into a Selections Table (400):
   the universal-time (401) corresponding to the selection of the topic by the user, and
   the address (URL) of the Broadcast Station Server (402),
received from the Wi-Fi Internet Gateway;
(1310) accessing the Broadcast Station Server (506) associated with the selected broadcast channel (515);
(1311) sending (517) to said Broadcast Station Server (506), the recorded universal-time (515) corresponding to the selection;
(1312) searching in a Program Timing File (520) stored on the Broadcast Station Server (506) for hyperlinks (1102) that can be activated at said universal-time (1104) (i.e., the hyperlinks that have been defined for the one or plurality of time intervals comprising said universal-time);
(1313) retrieving from the Program Timing File (620) located on the Broadcast Station Server (606), the names (or descriptions) and destination addresses (URLs) (617) of the hyperlinks that can be activated (1102);
(1314) storing the retrieved one or plurality of hyperlinks names and destination addresses (URLs) into the corresponding entry (703) in the Selections Table (700), (613).

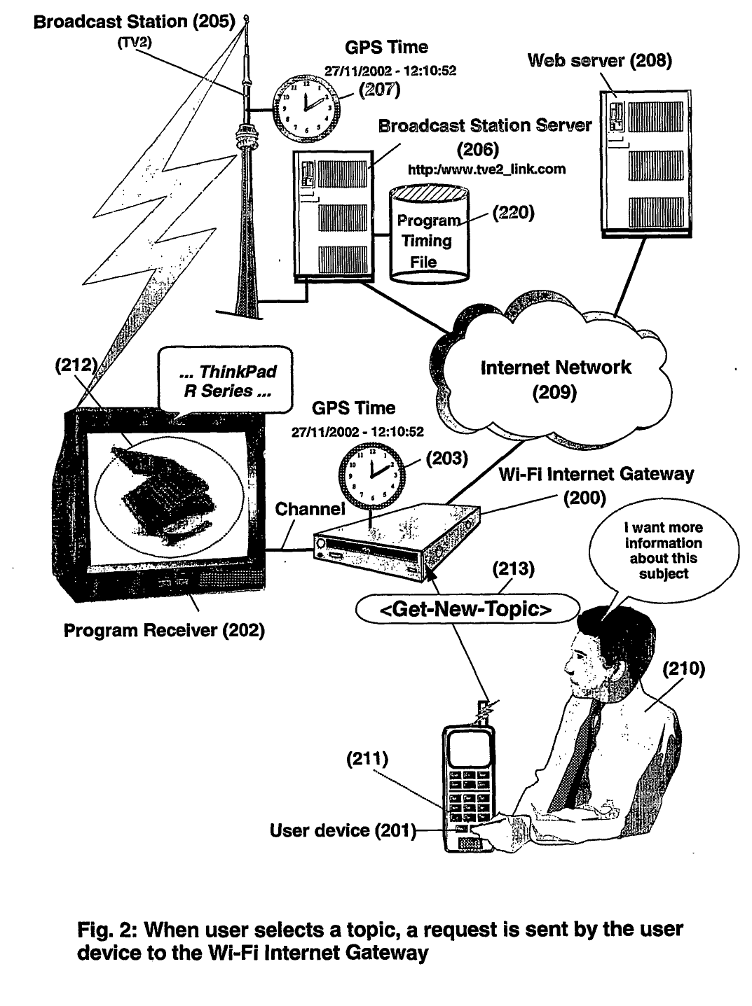

FIG. 2 illustrates how, when a user (210) perceives a topic of interest (212) in a broadcast program, he can immediately select this topic by pressing a reserved key (211) on his wireless device (201). A “get-new-topic” or selection command (213), activated by the user selection, is wirelessly transmitted from the wireless user device (201) to the Wi-Fi Internet Gateway (200).

Using a common universal-time system (203), (207) between the broadcast station (205) and the Wi-Fi Internet Gateway (200), allows to precisely synchronize the events recorded in the Broadcast Station Server (206) with the selection events (211) made by the user and detected by the Wi-Fi Internet Gateway (200). Therefore, the hyperlinks, active on the Broadcast Station (205) when the selections (211) of topics (212) are performed remotely by users (210), are identified without any error, independently of the value and fluctuation of transmission delays generated between user devices (201) and Broadcast Station Server (206) through the Internet network (209).

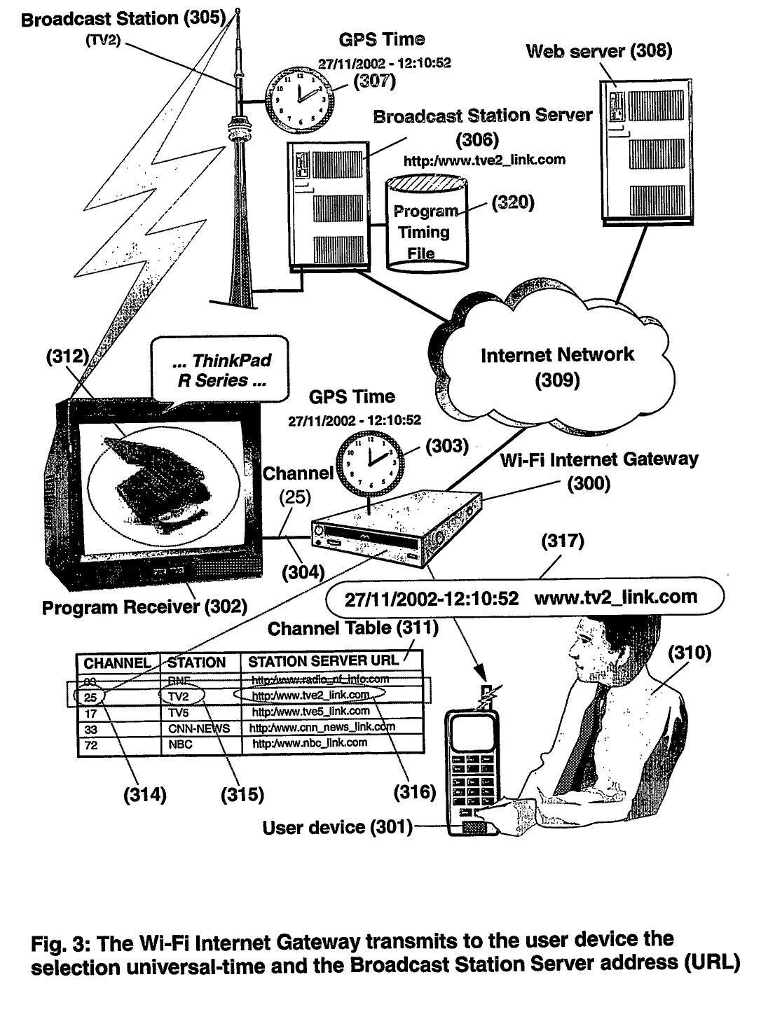

FIG. 3 illustrates how, when a “get-new-topic” or selection command (213) is received from the wireless user device (201), the Wi-Fi Internet Gateway (300):
immediately determines the universal-time by means of a universal-time receiver (e.g., 27/11/2002—12:10:52 from GPS receiver) (303); and,
identifies the channel number (e.g., channel number 25) selected on the broadcast program receiver (302) by means of a connection (304) with this receiver (302).

Using the selected channel number (e.g., channel number 25) (314), the Broadcast Station (e.g., TV2) (315), (305) for which the broadcast program receiver (302) is tuned, and the address (URL e.g., http:/www.tve2_link.com) (316) of the associated Broadcast Station Server (306) are identified in the Channel Table (311) located in the Wi-Fi Internet Gateway (300). The universal-time (e.g., GPS Time: 27/11/2002—12:10:52) corresponding to the selection, and the address (URL e.g., http:/www.tve2_link.com) of the associated Broadcast Station Server (306) are transmitted (317) from the Wi-Fi Internet Gateway (300) to the wireless user device (301).

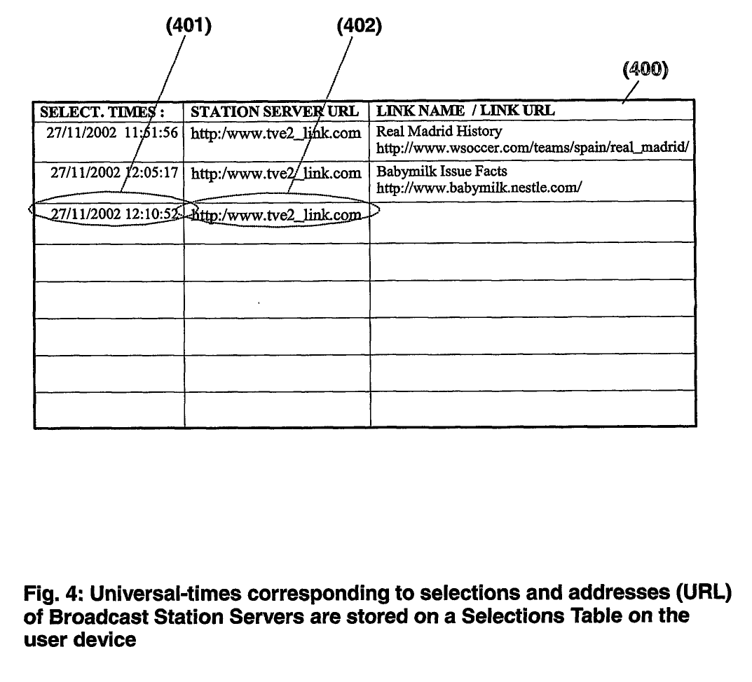

Each time the user device (310) receives from the Wi-Fi Internet Gateway (300), the universal-time (e.g., GPS Time: 27/11/2002—12:10:52) corresponding to the new selection, and the address (URL e.g., http:/www.tve2_link.com) of the Broadcast Station Server (306) (317), it stores this information (i.e., the universal-time (401), and the URL (402)) in the Selections Table (400). The following table, also shown in FIG. 4, shows how, for each selection made by the user,
the universal-time (e.g., GPS Time: 27/11/2002—12:10:52) (401), and
the URL (e.g., http:/www.tve2_link.com) (402) of the associated Broadcast Station Server (306),

are stored.

| SELECT. TIMES: | STATION SERVER URL | LINK NAME/LINK URL |
|---|---|---|
| 27/11/2002 11:51:56 | http:/www.tve2_link.com | Real Madrid History |
| | | http://www.wsoccer.com/teams/spain/real_madrid/ |
| 27/11/2002 12:05:17 | http:/www.tve2_link.com | Babymilk Issue Facts |
| | | http://www.babymilk.nestle.com/ |
| 27/11/2002 12:10:52 | http:/www.tve2_link.com | |

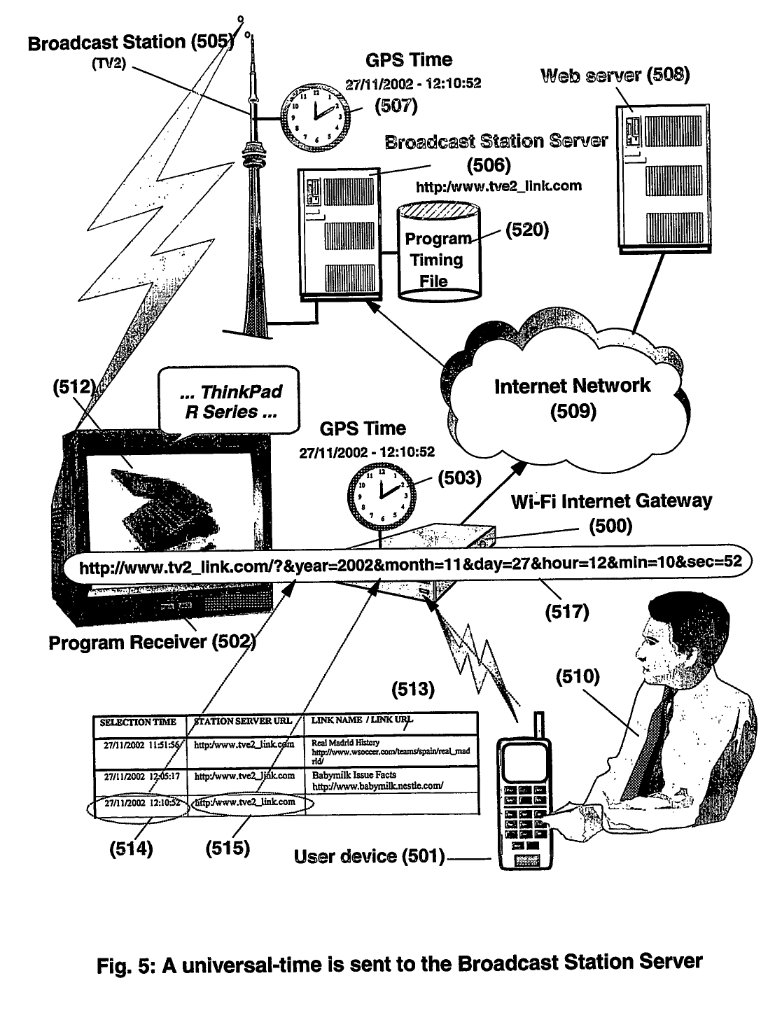

FIG. 5 shows how, using the address or URL (515), (402) of the Broadcast Station Server (506) (e.g., http:/www.tve2_link.com) the user device (501) sends a request (517) to the Broadcast Station Server (506) to retrieve one or plurality hyperlinks related to the topic or sequence broadcast by the Broadcast Station (505) at the universal-time (514), (401) corresponding to the selection made by the user.

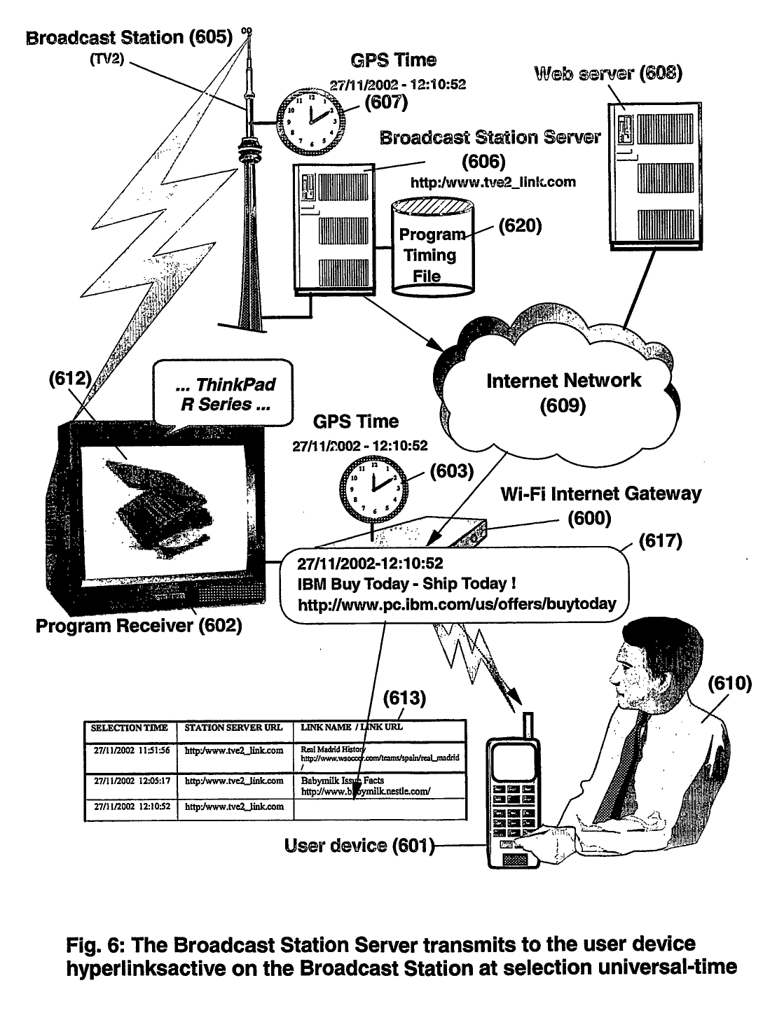

FIG. 6 shows how, when a request is received from a wireless user device (601), the Broadcast Station Server (606), using the selection universal-time comprised in the request (415), identifies in the Program Timing File (620), the one or plurality of hyperlinks (1103) active at the universal-time of the selection (1105). The information related to the identified hyperlinks (including the hyperlink description or short name and address or URL) (617) is extracted from the Program Timing File (620) and transmitted to the wireless user device (601).

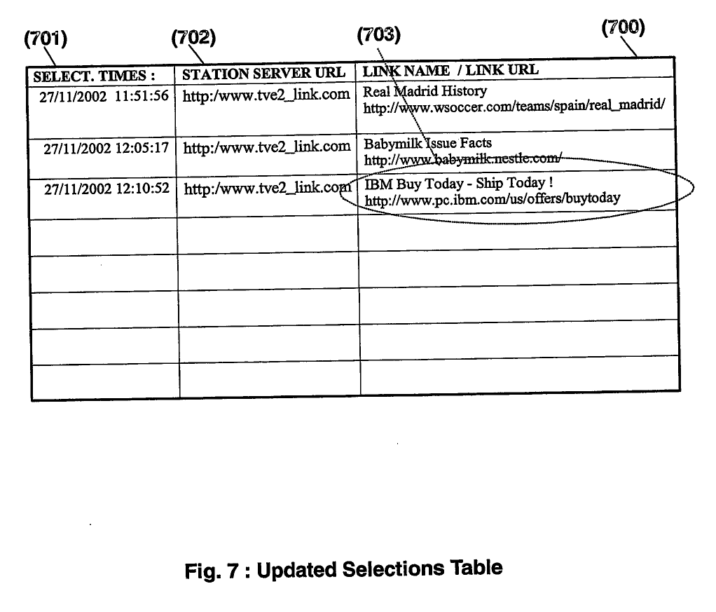

The following table, also shown in FIG. 7, shows how an hyperlink (703) defined by a name (e.g., “IBM Buy Today—Ship Today”) and an address (URL e.g., http://www.pc.ibm.com/us/offers/buytoday), is received from the Broadcast Station Server (606) and is updated in the Selections Table (700) located in the user device (601).

Method for Accessing Information Related to Topics Selected by the User

Once the radio auditor or television viewer (810) has selected one or a plurality of topics of interest (812) from broadcast programs and once the hyperlinks names and URLs (703) corresponding to the selected topics have been retrieved from the Broadcast Station Servers (806) and are stored or recorded in the Selections Table (700) located on the user device (801), the auditor or viewer can select and activate (811) any retrieved hyperlink to access multimedia information or service related to the corresponding selected topic. This information or service is located on servers (808) connected to the network (809) (e.g., Internet Web servers).

The method for an auditor or viewer of broadcast programs, of accessing information or services related to topics selected during the broadcasting of these programs, comprises the following steps of:
(1401) selecting in the Selections Table (700) located in the wireless user device, an hyperlink (816) using the hyperlink name (or description) or destination address (703), (816) retrieved from the Broadcast Station Server (806);
(1402) activating said hyperlink (811) using a browser program installed on the user device (801);
(1403) accessing the information and/or service located on a server (808) connected to the network (809) using the destination address retrieved with the selected hyperlink;
(1404) retrieving from the accessed server (908) connected to the network (909) and displaying this information and/or service (917) using the browser program installed on the user device (901).

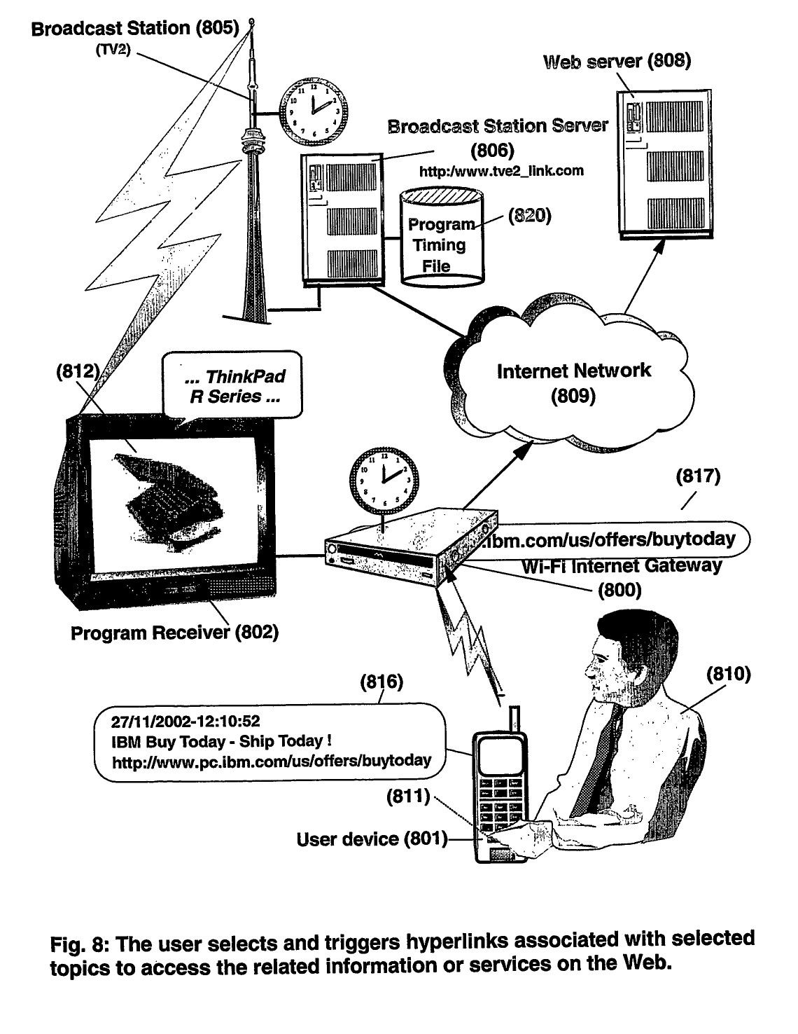

FIG. 8 shows how a user (810) selects (811) an hyperlink ((e.g., “IBM Buy Today—Ship Today”) (816), (703) in the Selections Table (700) and, using the URL encoded on selected entry, (e.g., http://www.pc.ibm.com/us/offers/buytoday/), triggers the hyperlink to retrieve through internet (809), the desired information or service located on a Web server (808). The corresponding request (817) is sent from the user device (801) to the hyperlinked Web server (808) (e.g., to: http://www.pc.ibm.com). It is important to note that, according to a particular embodiment of the invention, the triggering of an hyperlink (703) can be automatic, immediately after having been received by the user device (801).

FIG. 9 illustrates how the accessed Web server (908) retrieves and sends, through the Wi-Fi Internet Gateway (900), to the wireless user device (901), the information or service (917) related to the topic (e.g., “IBM Buy Today—Ship Today”)(912) that was selected by the user. The received information or service (917) is finally played or displayed to the user (910) by means of a browser program on the user device (901).

While the invention has been particularly shown and described with reference to a preferred embodiment, it will be understood that various changes in form and detail may be made therein without departing from the spirit, and scope of the invention.

1-23. (canceled)

24. A method, used in conjunction with a wireless device, for retrieving in real-time one or a plurality of hyperlinks related to a topic selected during a broadcast of a program on a channel, said method comprising:
responsive to a command that selected the topic during the broadcast of the program on the channel, sending a first request for retrieving a universal-time and an address of a server associated with the channel, said first request being directed to a wireless internet gateway connected to the server via a communication network, said universal-time pertaining to when the command was performed;
receiving the universal-time and the address of the server from the wireless internet gateway in response to the first request;
sending a second request to the server via the wireless internet gateway using the received address of the server, for retrieving the one or a plurality of hyperlinks related to the selected topic, said second request transmitting to the server the received universal-time from which the one or plurality of hyperlinks may be determined by the server;
retrieving the one or plurality of hyperlinks from the server via the wireless internet gateway; and
recording the retrieved one or plurality of hyperlinks,
wherein said sending the first request, said receiving the universal-time and the address of the server, said sending the second request, said retrieving the one or plurality of hyperlinks, and said recording the retrieved one or plurality of hyperlinks are performed by the wireless device.

25. The method of claim 24, wherein the server comprises a table that associates the one or a plurality of hyperlinks with a time interval that comprises the universal-time, thereby enabling the server to determine the one or a plurality of hyperlinks from the universal-time.

26. The method of claim 24, wherein the one or plurality of hyperlinks each comprise a hyperlink identifier and a destination address for accessing information related to the selected topic.

27. The method of claim 24, wherein the wireless internet gateway and the server are synchronized according to a same universal time.

28. The method of claim 24, wherein the method further comprises:
storing, by the wireless device, the received address of the server, the received universal-time, and the retrieved one or plurality of hyperlinks in a selections table.

29. The method of claim 28, wherein the method further comprises:
selecting from the selections table a hyperlink of the one or plurality of hyperlinks;
activating the selected hyperlink using a browser program installed on the wireless device; and
accessing information related to the selected topic on a server connected to the communication network at a destination address of the hyperlink,
wherein said selecting from the selections table, said activating the selected hyperlink, and said accessing information are performed by the wireless device.

30. The method of claim 24, wherein the wireless device is a mobile wireless device selected from the group consisting of a cellular phone, a Personal Data Assistant (PDA), a wearable computer, and a notebook computer.

31. The method of claim 24, wherein the communication network is an Internet Protocol (IP) network, wherein the server is a web server, wherein the wireless device comprises a web browser, and wherein the address of the server is a Uniform Resource Locator (URL) address.

32. The method of claim 24, wherein the wireless device comprises a computer program having instructions therein, and wherein said sending the first request, said receiving the universal-time and the address of the server, said sending the second request, said retrieving the one or plurality of hyperlinks, and said recording the retrieved one or plurality of hyperlinks are performed by execution of the instructions in the wireless device.

33. A system comprising a wireless device, said wireless device adapted to operate in conjunction with a method for retrieving in real-time one or a plurality of hyperlinks related to a topic selected during a broadcast of a program on a channel, said method comprising:
responsive to a command that selected the topic during the broadcast of the program on the channel, sending a first request for retrieving a universal-time and an address of a server associated with the channel, said first request being directed to a wireless internet gateway connected to the server via a communication network, said universal-time pertaining to when the command was performed;
receiving the universal-time and the address of the server from the wireless internet gateway in response to the first request;
sending a second request to the server via the wireless internet gateway using the received address of the server, for retrieving the one or a plurality of hyperlinks related to the selected topic, said second request transmitting to the server the received universal-time from which the one or plurality of hyperlinks may be determined by the server;
retrieving the one or plurality of hyperlinks from the server via the wireless internet gateway; and
recording the retrieved one or plurality of hyperlinks,
wherein said sending the first request, said receiving the universal-time and the address of the server, said sending the second request, said retrieving the one or plurality of hyperlinks, and said recording the retrieved one or plurality of hyperlinks are performed by the wireless device.

34. The system of claim 33, wherein the server comprises a table that associates the one or a plurality of hyperlinks with a time interval that comprises the universal-time, thereby enabling the server to determine the one or a plurality of hyperlinks from the universal-time.

35. The system of claim 33, wherein the one or plurality of hyperlinks each comprise a hyperlink identifier and a destination address for accessing information related to the selected topic.

36. The system of claim 33, wherein the wireless internet gateway and the server are synchronized according to a same universal time.

37. The system of claim 33, wherein the wireless device comprises a selections table, and wherein the method further comprises:
storing the received address of the server, the received universal-time, and the retrieved one or plurality of hyperlinks in the selections table.

38. The system of claim 37, wherein the method further comprises:
selecting from the selections table a hyperlink of the one or plurality of hyperlinks;
activating the selected hyperlink using a browser program installed on the wireless device; and
accessing information related to the selected topic on a server connected to the communication network at a destination address of the hyperlink,
wherein said selecting from the selections table, said activating the selected hyperlink, and said accessing information are performed by the wireless device.

39. The system of claim 33, wherein the wireless device is a mobile wireless device selected from the group consisting of a cellular phone, a Personal Data Assistant (PDA), a wearable computer, and a notebook computer.

40. The system of claim 33, wherein the communication network is an Internet Protocol (IP) network, wherein the server is a web server, wherein the wireless device comprises a web browser, and wherein the address of the server is a Uniform Resource Locator (URL) address.

41. The system of claim 33, wherein the wireless device comprises a computer program, and wherein the computer program comprises instructions that when executed in the wireless device performs said method.

42. A method, used in conjunction with a wireless internet gateway, for retrieving in real-time one or a plurality of hyperlinks related to a topic selected during a broadcast of a program on a channel, said method comprising:
responsive to a first request received by the wireless internet gateway from a wireless device for a universal-time and an address of a server associated with the channel, retrieving the universal-time from a system adapted to determine the universal-time, identifying the address of the server, and sending the retrieved universal-time and the identified address of the server to the wireless device, said universal-time pertaining to when a command selecting the topic during the broadcast of the program on the channel was performed, said wireless internet gateway being connected to the server via a communication network; and
after sending the retrieved universal-time and the identified address of the server to the wireless device, and responsive thereafter to a second request received by the wireless internet gateway from the wireless device for retrieving the one or a plurality of hyperlinks from the server using the address of the server, retrieving the one or plurality of hyperlinks from the server and transmitting the retrieved one or plurality of hyperlinks to the wireless device,
wherein said retrieving the universal-time, said identifying the address of the server, said sending the universal-time and the address of the server are performed by the wireless internet, and said retrieving the one or plurality of hyperlinks are performed by the wireless internet gateway.

43. The method of claim 42, wherein the wireless internet gateway is connected to a program receiver that receives program broadcast on the channel, wherein the wireless internet gateway comprises a channel table that associates the address of the server with the channel, and wherein identifying the address of the server comprises:
receiving, by the wireless internet gateway, an identification of the channel from the program receiver; and
identifying, by the wireless internet gateway, the address of the server from the channel table.

44. The method of claim 42, wherein the server comprises a table that associates the one or a plurality of hyperlinks with a time interval that comprises the universal-time, thereby enabling the server to determine the one or a plurality of hyperlinks from the universal-time.

45. The method of claim 42, wherein the one or plurality of hyperlinks each comprise a hyperlink identifier and a destination address for accessing information related to the selected topic.

46. The method of claim 42, wherein the wireless internet gateway and the server are synchronized according to a same universal time.

47. The method of claim 42, wherein the communication network is an Internet Protocol (IP) network, wherein the server is a web server, wherein the wireless device comprises a web browser, and wherein the address of the server is a Uniform Resource Locator (URL) address.

48. The method of claim 42, wherein the wireless internet gateway comprises a computer program having instructions therein, and wherein said retrieving the universal-time, said identifying the address of the server, said sending the universal-time and the address of the server are performed by the wireless internet, and said retrieving the one or plurality of hyperlinks are performed by execution of the instructions in the wireless internet gateway.

49. A system comprising a wireless internet gateway, said wireless internet gateway adapted to operate in conjunction with a method for retrieving in real-time one or a plurality of hyperlinks related to a topic selected during a broadcast of a program on a channel, said method comprising:
responsive to a first request received by the wireless internet gateway from a wireless device for a universal-time and an address of a server associated with the channel, retrieving the universal-time from a system adapted to determine the universal-time, identifying the address of the server, and sending the retrieved universal-time and the identified address of the server to the wireless device, said universal-time pertaining to when a command selecting the topic during the broadcast of the program on the channel was performed, said wireless internet gateway being connected to the server via a communication network; and
after sending the retrieved universal-time and the identified address of the server to the wireless device, and responsive thereafter to a second request received by the wireless internet gateway from the wireless device for retrieving the one or a plurality of hyperlinks from the server using the address of the server, retrieving the one or plurality of hyperlinks from the server and transmitting the retrieved one or plurality of hyperlinks to the wireless device,
wherein said retrieving the universal-time, said identifying the address of the server, said sending the universal-time and the address of the server are performed by the wireless internet, and said retrieving the one or plurality of hyperlinks are performed by the wireless internet gateway.

50. The system of claim 49, wherein the wireless internet gateway is connected to a program receiver that receives program broadcast on the channel, wherein the wireless internet gateway comprises a channel table that associates the address of the server with the channel, and wherein identifying the address of the server comprises:
receiving, by the wireless internet gateway, an identification of the channel from the program receiver; and
identifying, by the wireless internet gateway, the address of the server from the channel table.

51. The system of claim 49, wherein the server comprises a table that associates the one or a plurality of hyperlinks with a time interval that comprises the universal-time, thereby enabling the server to determine the one or a plurality of hyperlinks from the universal-time.

52. The system of claim 49, wherein the one or plurality of hyperlinks each comprise a hyperlink identifier and a destination address for accessing information related to the selected topic.

53. The system of claim 49, wherein the wireless internet gateway and the server are synchronized according to a same universal time.

54. The system of claim 42, wherein the communication network is an Internet Protocol (IP) network, wherein the server is a web server, wherein the wireless device comprises a web browser, and wherein the address of the server is a Uniform Resource Locator (URL) address.

55. The system of claim 49, wherein the wireless internet gateway comprises a computer program having instructions therein, and wherein said retrieving the universal-time, said identifying the address of the server, said sending the universal-time and the address of the server are performed by the wireless internet, and said retrieving the one or plurality of hyperlinks are performed by execution of the instructions in the wireless internet gateway.
